(19) United States
(12) Patent Application Publication
(10) Pub. No.: US 2015/0057141 A1
(43) Pub. Date: Feb. 26, 2015

(54) CENTRIFUGE AND SYSTEM FOR MANAGING OPERATION DATA OF CENTRIFUGE

(71) Applicant: HITACHI KOKI CO., LTD., Tokyo (JP)

(72) Inventors: Hiroatsu Toi, Ibaraki (JP); Hiroyuki Takahashi, Ibaraki (JP)

(21) Appl. No.: 14/465,373

(22) Filed: Aug. 21, 2014

(30) Foreign Application Priority Data
Aug. 24, 2013 (JP) 2013-174029

(51) Int. Cl. B04B 13/00; B04B 15/02; B04B 9/10

(52) U.S. Cl. CPC B04B 13/00; B04B 9/10; B04B 15/02
USPC 494/10

(57) ABSTRACT

A centrifuge including: a rotor configured to separate a sample; a driving unit configured to rotate the rotor; a control device configured to control the driving unit and generate operation data; a data storage device configured to store the operation data; and a communication unit configured to connect the centrifuge with another centrifuge, wherein the storage device has a first storage area configured to store the operation data of the centrifuge, and a second storage area configured to store operation data of the other centrifuge acquired through the communication unit.

### CROSS-REFERENCE TO RELATED APPLICATIONS

This application claims priority from Japanese Patent Application No. 2013-174029 filed on Aug. 24, 2013, the entire contents of which are incorporated herein by reference.

### TECHNICAL FIELD

Aspects of the present invention relate to a centrifuge, and particularly, to improvement of a method of storing operation data in a system including a plurality of centrifuges connected by a network.

### BACKGROUND

As one kind of centrifuge for performing a variety of processes by using centrifugal force, there is a centrifuge in which a liquid sample is continuously run and particles in the liquid sample is centrifuged inside a rotor. Centrifuges are widely used for separating particles which do not settle out or are unlikely to settle out in a general gravitational field, and are widely used as installations for separating and refining, for example, medicines, vaccines, or the like. In a case of a centrifuge or a centrifugal separator which is usable as an installation for producing medical supplies, in order to trace the stock solution of a vaccine centrifuged by an operation of the centrifuge or the centrifugal separator, from the vaccine which is a final product, it is required to accurately generate and save operation data of the centrifuge as a vaccine production record.

For this production record, there are known methods of transmitting operation data from a centrifuge to an external storage device through a network and storing the operation data in the external storage device in a system including a plurality of centrifuges connected by the network as disclosed in JP-A-2011-189324 and JP-A-H11-328038.

### SUMMARY

The system including centrifugal separators, which is disclosed in JP-A-2011-189324, is a system in which a plurality of centrifugal separators connected to a network generates operation data, and a data management device arranged on the network receives and stores the operation data. In this system, since the data management device stores operation data, there is a risk that if the data management device breaks down due to a breakdown of a hard disk, operation data of all centrifugal separators connected to the data management device may be lost. Also, there is a risk that if the network is disconnected for any reason, whereby communication becomes impossible, a trouble that it is impossible to read operation data from each centrifugal separator and store the operation data, and a trouble that a centrifugal separator, which is incapable of transmitting operation data to the data management device, cannot perform a centrifuging operation may occur.

Although not being specialized for centrifugal separators, a system disclosed in JP-A-H11-328038 is a system in which a central processing unit arranged on a network generates data and stores the data in a plurality of external storage devices connected to the network. In a case of applying this system to centrifugal separators, since a plurality of external storage devices is provided, it is possible to reduce a risk of operation data loss due to a breakdown of a storage device, and thus the application is effective. However, during an abnormal state such as a disconnection of the network, since it is impossible to store operation data in the external storage devices, a trouble that a centrifugal separator, which is incapable of transmitting operation data, cannot perform a centrifuging operation occurs.

The present invention is made in view of the above described background, and an object of the present invention is to provide a centrifuge and a system for managing operation data of a centrifuge, in which a risk that operation data of the centrifuge will be lost can be minimized, and in which a centrifuging operation can be continued even in a case where a connection between a centrifuge and an external storage device is incomplete.

Another object of the present invention is to provide a centrifuge and a system for managing operation data of a centrifuge, in which redundancy is given to operation data of each centrifuge, whereby the operation data is reliably stored and a risk of data loss is reduced.

A further object of the present invention is to provide a centrifuge and a system for managing operation data of a centrifuge, in which it is possible to easily integrate, arrange, and reuse operation data multiply stored, and which have improved operability.

According to an aspect of the present invention, there is provided a centrifuge including: a rotor configured to separate a sample; a driving unit configured to rotate the rotor; a control device configured to control the driving unit and generate operation data; a data storage device configured to store the operation data; and a communication unit configured to connect the centrifuge with another centrifuge, wherein the storage device has a first storage area configured to store the operation data of the centrifuge, and a second storage area configured to store operation data of the other centrifuge acquired through the communication unit.

According to another aspect of the present invention, there is provided a centrifuge including: a rotor configured to separate a sample; a driving unit configured to rotate the rotor; a control device configured to control the driving unit and generate operation data; a data storage device configured to store the operation data; and a communication unit configured to connect the centrifuge with another centrifuge, wherein the control device is configured to generate operation data which is a record of an operation status according to a centrifuging operation, and wherein the control device is configured to store the operation data in the data storage device, and transmit the operation data to the other centrifuge connected through the communication unit.

According to another aspect of the present invention, there is provided a system for managing operation data of a centrifuge, the system including: a plurality of centrifuges, each of the plurality of centrifuges including: a rotor configured to separate a sample, a driving unit configured to rotate the rotor, a control device configured to control the driving unit and generate operation data, a communication unit, and a data storage device configured to store the operation data, wherein the storage device of each of the plurality of centrifuges has a first storage area for storing the operation data of the corresponding centrifuge, and a second storage area for storing the operation data of another centrifuge acquired through the communication unit.

Accordingly, in addition to storing the operation data generated by the centrifuge in the data storage device of the centrifuge, the operation data is also transmitted to another centrifuge connected through the communication unit such that the operation data is also stored in the other centrifuge. Therefore, it is possible to significantly reduce a risk of operation data loss due to a breakdown of the data storage device. Also, even if a network is in an abnormal state such as a disconnected state, since the centrifuge has a built-in data storage device, it is possible to continue an operation without stopping the centrifuge. Further, it is unnecessary to provide an apparatus (for example, a server apparatus) dedicated for data storing.

According to another aspect of the present invention, there is provided a centrifuge including: a rotor configured to separate a sample; a driving unit configured to rotate the rotor; a control device configured to control the driving unit; and a communication unit configured to connect the centrifuge with an external centrifuge, wherein the control device includes a clocking unit, and wherein the control device has a time synchronization function of performing time synchronization with the external centrifuge through the communication unit.

Accordingly, since the time synchronization function is provided, it is possible to synchronize the times of a plurality of centrifuges by a simple operation.

### BRIEF DESCRIPTION OF DRAWINGS

FIG. 1 is a perspective view illustrating the overall configuration of a centrifuge 1 according to an illustrative embodiment of the present invention;

FIG. 2 is a cross-sectional view illustrating a centrifugal separator 100 of FIG. 1;

FIG. 3 is a block diagram schematically illustrating a control device unit 200;

FIG. 4 is a view illustrating the configuration of a system including a plurality of centrifuges 1 connected by a network;

FIG. 5 is a view illustrating the contents of setting condition data 500 which is stored in the centrifuge 1;

FIG. 6 is a view illustrating the contents of user information data 550 which is stored in the centrifuge 1;

FIG. 7 is a view illustrating the contents of audit trail data 400 which is stored in the centrifuge 1;

FIG. 8 is a view illustrating the contents of operation parameter data 450 which is stored in the centrifuge 1;

FIG. 9 is a flow chart illustrating a procedure in which the centrifuge 1 according to the illustrative embodiment of the present invention generates, stores, and transmits the setting condition data 500, the user information data 550, the audit trail data 400, and the operation parameter data 450;

FIG. 10 is a flow chart illustrating a procedure in which another centrifuge 1 according to the illustrative embodiment of the present invention receives and stores the setting condition data 500, the user information data 550, the audit trail data 400, and the operation parameter data 450;

FIG. 11 is a view illustrating a menu screen 300 which is displayed on an operation panel 210 of FIG. 1;

FIG. 12 is a view illustrating a screen which is displayed on the operation panel 210 if an icon “MACHINE NUMBER SETTING” 301 is selected in FIG. 11;

FIG. 13 is a view illustrating a screen which is displayed on the operation panel 210 if an icon “DATE/TIME SETTING” 302 is selected in FIG. 11;

FIG. 14 is a view illustrating a screen which is displayed on the operation panel 210 if an icon “NETWORK SETTING” 303 is selected in FIG. 11;

FIG. 15 is a view illustrating a screen which is displayed on the operation panel 210 if an icon “TIME SYNCHRONIZATION SETTING” 304 is selected in FIG. 11;

FIG. 16 is a flow chart illustrating a procedure of a data integrating process which is performed on the control device (201) side of a centrifuge 1-11 of the master side.

FIG. 17 is a flow chart illustrating a procedure of a data integrating process of a centrifuge 1-1N of the slave side;

FIG. 18 is a flow chart illustrating a detailed procedure of a data integrating process of STEP S706 of FIG. 16;

FIG. 19 is a flow chart illustrating a detailed procedure of a data integrating process of STEP S806 of FIG. 17;

FIG. 20 is a view illustrating a setting-history reference screen 360; and

FIG. 21 is a view illustrating a user list screen 380 which represents all users belonging to the same group.

### DETAILED DESCRIPTION

### First Illustrative Embodiment

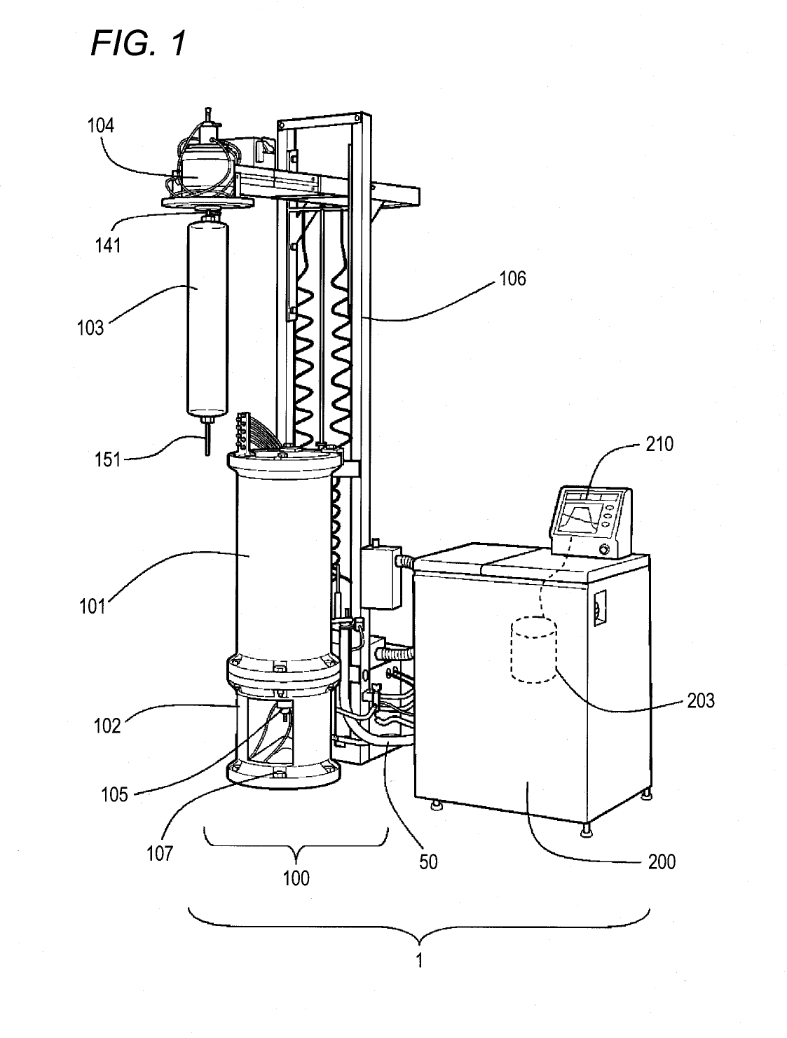

Hereinafter, an illustrative embodiment of the present invention will be described with reference to the accompanying drawings. Identical portions are denoted by the same reference symbols throughout the drawings, and will not be repeatedly described. FIG. 1 is a perspective view illustrating the overall configuration of a centrifuge according to an illustrative embodiment of the present invention. A centrifuge (a centrifugal separator) 1 is composed mainly of a centrifugal separator 100 and a control device unit 200, and the centrifugal separator 100 and the control device unit 200 are connected to each other by a wiring/piping group 50.

The centrifugal separator 100 includes a cylindrical chamber 101 serving as a centrifuging chamber, a base 102 which supports the chamber 101, a rotor 103 which is accommodated inside the chamber 101 so as to freely move into and out of the chamber, and rotates at a high speed, an upper driving unit 104 which is disposed at an upper portion of the chamber 101, and rotates the rotor 103 with the rotor 103 suspended from the upper driving unit 104, a lower rotation supporting unit 105 that is attached at a lower portion of the chamber 101 and is composed of a lower bearing and the like, and a lift 106 for moving the upper driving unit 104 in a vertical direction and a front-rear direction. On the upper and lower sides of the rotor 103, an upper shaft 141 and a lower shaft 151 which are two rotating shafts having through-holes formed therein are provided.

The control device unit 200 includes a control device (to be described below) for performing a variety of control such as control on rotation of the upper driving unit 104, a cooling means for cooling the rotor 103, and so on. In the present illustrative embodiment, the control device unit 200 contains a storage device 203 for storing databases. At an upper portion of the control device unit 200, an operation panel 210 for acting as an input means for receiving information inputs from a user, and displaying information for the user is provided. The operation panel 210 is configured using, for example, a touch panel type liquid crystal display, and is electrically connected to the control device (to be described below). On the operation panel 210, an operation screen for setting operation parameters, instruction inputs of the operation parameters, and a variety of information such as an operation state are displayed.

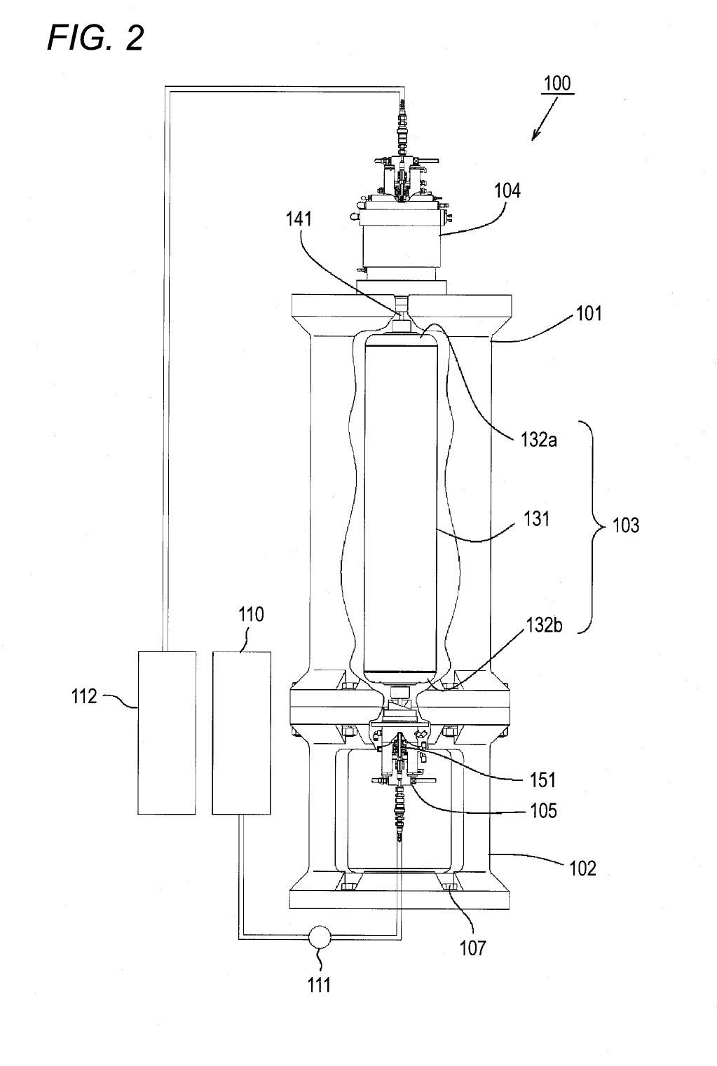

FIG. 2 is a cross-sectional view illustrating details of the configuration of the centrifugal separator 100. The centrifugal separator 100 includes a sample circulating means, which includes a sample tank 110 containing a liquid sample, a sample supply pump 111 for injecting the liquid sample retained in the sample tank 110 into the main body of the centrifuge, and a sample recovery tank 112 for recovering a supernatant liquid discharged through the upper driving unit 104 by continuous centrifuging. Further, the centrifugal separator 100 includes the chamber 101, the base 102 which holds the chamber 101, the upper driving unit 104, and the lower rotation supporting unit 105. The base 102 is fixed to a floor (not shown) by bolts 107. In the vicinity of the center of the upper portion of the base 102, a rotation supporting hole is formed, such that the lower rotation supporting unit 105 is attached to the base 102.

The liquid sample contained in the sample tank 110 is introduced from the lower rotation supporting unit 105 into the rotor 103 through the lower shaft 151 by the sample supply pump 111, and is centrifuged by the rotor 103 rotating at a high speed, and a supernatant liquid collected on the inner side in a radial direction by the centrifuging flows into the upper driving unit 104 through the upper shaft 141, and then is recovered in the sample recovery tank 112. The sample supply pump 111 is connected to a control device 201 (to be described below) by a signal line (not shown), such that supply of the sample is controlled by the control device 201.

The rotor 103 includes a cylindrical rotor body 131, and upper and lower rotor covers 132a and 132b which are attached to the upper and lower sides of the rotor body 131 by screwing. Here, at the axial centers of the upper and lower rotor covers 132a and 132b, sample path holes are formed, respectively. The rotor cover 132a is a structure to which the upper shaft 141 of the upper driving unit 104 is attached, and the rotor cover 132b is a structure to which the lower shaft 151 of the lower rotation supporting unit 105 is attached. The upper shaft 141 is rotated at a high speed by driving of a motor included in the upper driving unit 104, whereby the rotor 103 attached to the upper shaft 141 and the lower shaft 151 attached to the rotor 103 rotate together. At the axial centers of the upper shaft 141 and the lower shaft 151, sample path holes are formed, respectively, and these sample path holes are connected to the sample path holes formed in the rotor covers 132a and 132b. The opposite end portions of the upper shaft 141 and the lower shaft 151 to the rotor come into contact with an upper face seal and a lower face seal (both of which are not shown in the drawings), respectively.

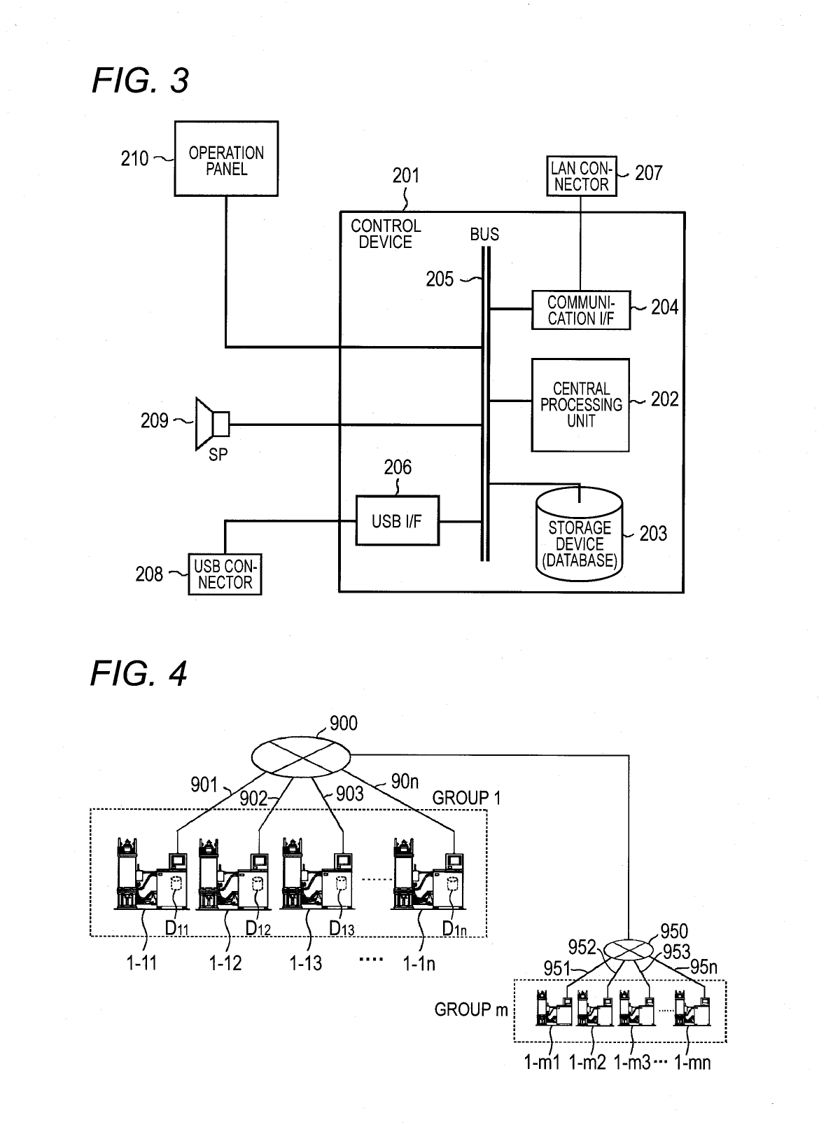

FIG. 3 is a block diagram schematically illustrating the control device unit 200. The control device 201 includes a central processing unit 202, a communication interface (I/F) 204, an USB interface (I/F) 206, and the storage device 203, which are connected by a data bus (BUS) 205, and the control device 201 is connected to the operation panel 210, a speaker 209, a LAN connector 207, and a USB connector 208. Further, the control device unit 200 includes a cooling device, a control circuit for controlling each unit of the centrifugal separator 100, a power supply device, an A/D converter, a D/A converter, and so on. However, in FIG. 3, only main portions related to the present invention are shown.

The central processing unit 202 carries generating of operation data of the centrifuge, storing of the operation data, a function of communication with an external device, and managing of a clocking function, and thus is configured so as to include a micro computer and the like. The central processing unit 202 may be implemented using a commercially available micro processor, and includes a clocking unit for managing time. The storage device 203 is for storing a variety of data of the centrifugal separator 100, such as setting condition data, operation data, and audit trail data, and is configured by a known device such as a hardware device or a semiconductor storage device, and it is possible to randomly read information from the storage device 203. In the present illustrative embodiment, since the centrifuge stores operation data related to itself and creates and stores a database of each of a plurality of other centrifuges, it is preferable that the storage device 203 should have a sufficient storage capacity. Also, it is preferable to secure (assign) some storage areas for storing operation data of centrifuges assumed to be connected, in the storage area of the storage device 203. The communication interface 204 is a circuit for performing communication with an external device through a network line, and is a circuit for using a known general communication system such as Ethernet (registered as a trade mark) or RS485. As the LAN connector 207, a connector such as RJ-45 registered in the Federal Communications Commission can be used.

The USB interface 206 is a circuit for a connection with the USB connector 208, and as the USB connector 208, a connector according to universal serial bus standards can be used. An external storage device (such as an external hard disk device or an external semiconductor memory device) (not shown) can be connected to the USB connector 208, such that it is possible to copy or move data in the storage device 203 into the external storage device. In the present illustrative embodiment, since copied or moved data can be held in the external storage device, it is required only to secure a predetermined amount of storage area of the storage device 203 in the centrifuge 1, and it is possible to efficiently use the storage device 203. Also, if it becomes impossible to store data in the storage device 203 due to any trouble, an external storage device may be connected to the USB connector 208, and data stored in the storage device 203 may be written in the external storage device. The speaker 209 is for outputting warning sounds and a variety of voice guidance to the user, and according to operations or displays on the operation panel 210, operation sounds, alarm sounds, and the like are output. The operation panel 210 is implemented by a touch panel type liquid crystal display, and acts not only as an input device for allowing the user to input information but also as a display for displaying operation data and a variety of information for the user. Instead of using a touch panel type liquid crystal display as the operation panel 210, an input device which is composed of a keyboard and a variety of buttons, and a known display may be separately configured. Also, as the operation panel 210, an integrated personal computer such as a so-called panel computer may be configured such that the operation panel 210 has all or part of the functions of the control device 201.

FIG. 4 is a view illustrating the configuration of a system including a plurality of centrifuges 1 connected by a network 900. In the present illustrative embodiment, the individual centrifuges 1 have the same configuration, and the plurality of centrifuges 1-11 to 1-1n are connected to one another by connection cables 901, 902, . . . , and 90n. The network 900 acting as a communication unit is a communication network, for example, a local area network (LAN), in which computers, communication devices, printers, and the like in a building are connected by cables, a wireless communication unit, or the like, and exchanges data with one another. Here, for convenience of explanation, the centrifuges are also denoted by reference symbols including branch numbers like 1-11, 1-12, 1-13, . . . , and 1-1n, and the number of centrifuges connectable to one network is defined to n. The communication network is not limited to one network 900. The network 900 can be connected to another network 950 such that communication with centrifuges 1-ml to 1-mn is possible. Operation data of any one centrifuge 1 is transmitted to the other centrifuges 1 assigned through at least one of the network 900 and the network 950. For example, operation data of the centrifuge 1-11 connected to the network 900 can be transmitted to all centrifuges 1-11 to 1-1n included in Group 1. Also, in terms of backup or the like, the data may be transmitted to a specific centrifuge 1 or all centrifuges 1 belonging to Group m which is another group, or a server (not shown), or the like. Each of the centrifuges 1 has a built-in control device 201, which has a data generating function of generating operation data (to be described below) and stores the generated operation data in the storage device 203 of the corresponding centrifuge. Also, the control device 201 transmits the operation data to one or more other centrifuges 1 belonging to the same group through the network 900, such that the transmitted operation data is stored in the storage device 203 of each of the one or more other centrifuges.

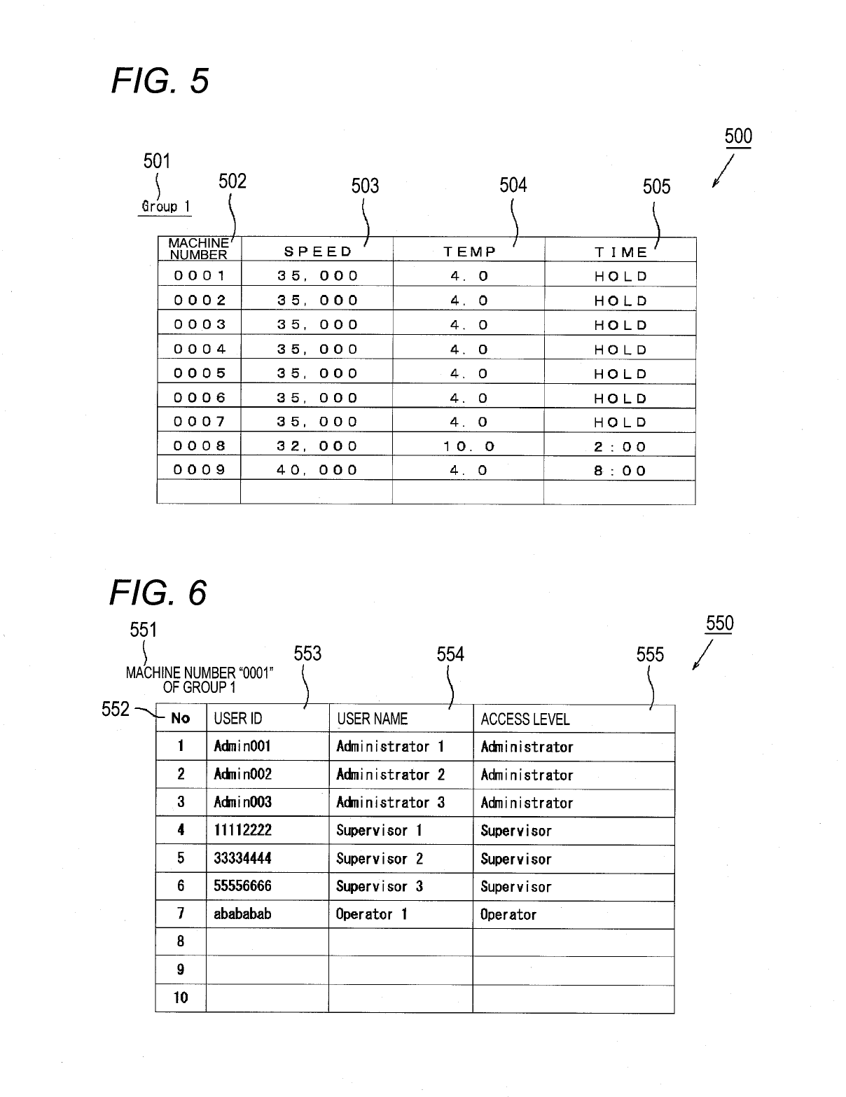

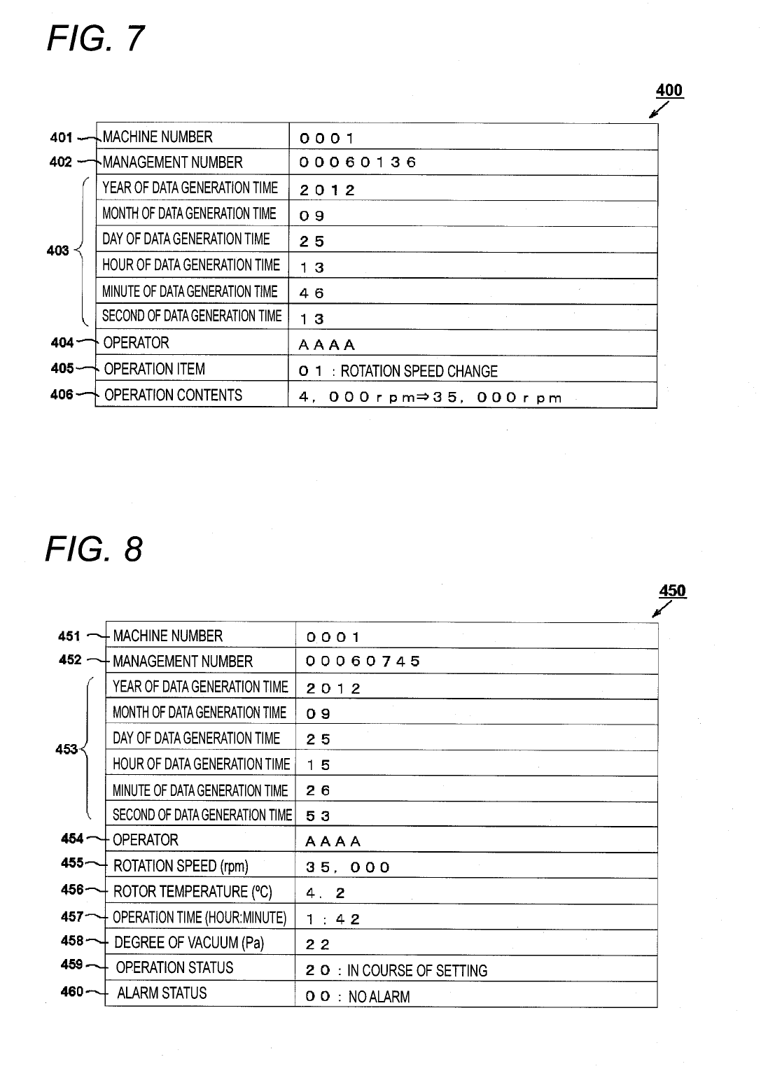

Subsequently, operation data which a centrifuge 1 generates will be described. Operation data mainly includes four kinds of data, that is, setting condition data 500 shown in FIG. 5, user information data 550 shown in FIG. 6, audit trail data 400 shown in FIG. 7, and operation parameter data 450 shown in FIG. 8. The setting condition data 500 represents operation conditions for operating centrifuges 1, and can be generally set only by a user with administrator authority. In the present illustrative embodiment, in order for a plurality of centrifuges 1 of the same group to operate in the same conditions, it is convenient to be able to use one centrifuge 1 to set the operation conditions for the other centrifuges. Therefore, the present illustrative embodiment is configured such that according to the level of authority of a user, it is possible to use any one centrifuge 1 to set the conditions for the other centrifuges. The user information data 550 is user information necessary to operate (log in to) the centrifuge 1. In the present illustrative embodiment, in order to use a plurality of centrifuges 1 of the same group, it is convenient to be able to use one centrifuge 1 to set user information of the other centrifuges. Therefore, the present illustrative embodiment is configured such that it is possible to use any one centrifuge 1 to set user information of the other centrifuges. The audit trail data 400 is operation data mainly related to an operation on the centrifuge 1, and is generated if a user operates the centrifuge 1. Meanwhile, the operation parameter data 450 shown in FIG. 8 is automatically generated at predetermined intervals during an operation of the centrifuge 1, and is configured so as to include data (or a log) which is a record of the operation status of the centrifuge 1, and is referred to as an operation status record log.

FIG. 5 is a view illustrating items of the setting condition data 500 which is stored in a centrifuge 1. In the setting condition data 500, with respect to each of the centrifuges 1 belonging to Group 1 set as an item “GROUP NUMBER” 501, an item “MACHINE NUMBER (MODEL NAME)” 502, an item “SPEED (ROTATION SPEED OF ROTOR)” 503, an item “TEMP (SET TEMPERATURE OF ROTOR)” 504, and an item “TIME” (which represents an operation time and in which “HOLD” represents to continuously rotate the rotor until a stop instruction is received) 505 are set. The setting condition data 500 shown in FIG. 5 represents that in Group 1, nine centrifuges 1 have been connected, and centrifuges 1 having machine numbers 0001 to 0007 are operated in the same conditions, and centrifuges 1 machine numbers 0008 and 0009 are operated in different setting conditions. If setting conditions to be referred to by each centrifuge 1 is stored in a database of the corresponding centrifuge 1, on the occasion of using each centrifuge to input data, it is possible to easily recognize the setting conditions of the other centrifuges 1. For example, in a case of using the plurality of centrifuges 1 to produce a vaccine, it is often to operate the centrifuges in the same conditions. In this case, a user who desires to set conditions for a centrifuge can refer to the setting conditions of any other centrifuge 1, and sometimes copy the setting conditions of any other centrifuge, thereby easily and correctly inputting the same operation status. Also, in a case where a user has administrator authority, the user may be able to use the operation panel 210 of one centrifuge 1 to set setting condition data 500 for the other centrifuges 1. Since each of the centrifuges 1-11 to 1-1n stores the setting condition data of the plurality of centrifuges as described above, before a centrifuging operation of each centrifuge starts, a corresponding control device compares the set operation conditions with setting condition data of each of the other centrifuges, or the setting condition data of the corresponding centrifuge changed by another centrifuge, thereby checking whether there is a difference between them, and in a case where there is a difference, a confirmation operation for inquiring the user about whether to correct is possible.

FIG. 6 is a view illustrating items of the user information data 550 which is stored in the centrifuge 1. The user information data 550 represents the list of users registered in the centrifuge (here, the centrifuge 1-11 belonging to a group number 1 and having a machine number “0001”) set in an item “MACHINE NUMBER” 551. Here, an example in which seven users have been registered in the centrifuge 1-11 is shown, and an item “SERIAL NUMBER” 552, an item “USER ID” 553, an item “USER NAME” 554, and an “ACCESS LEVEL” 555 are set. The access levels of the users are classified into classes “Administrator”, “Supervisor”, and “Operator”, and according to the access levels, authority to operate the centrifuge 1 is restricted. An administrator can perform all operations on the centrifuge 1, and can operate a setting screen of the centrifuge 1, and can also change settings of operation conditions. It is preferable to especially limit the number of people registrable as administrators (for example, to 3). A supervisor is restricted to operating a part of the functions of the centrifuge 1. A supervisor cannot make user information be displayed, or manipulate user information. A supervisor can change settings of operation conditions. An operator is restricted to operating a part of the functions of the centrifuge 1. An operator cannot make user information be displayed, or manipulate user information, and cannot change settings of operation conditions although being able to see display of the operation conditions. The user information data 550 shown in FIG. 6 is the list of only the machine number 0001, that is, the list of the corresponding centrifuge. However, since the set list (user information data 550) of each centrifuge is transmitted to the other centrifuges and is registered in the databases of the other centrifuges, the individual centrifuges have all user information data 550 belonging to the same group. Therefore, it is possible to refer to or copy them, thereby correctly inputting the same users without omission.

FIG. 7 is a view illustrating items of the audit trail data 400 which is stored in the centrifuge 1. The audit trail data 400 is a record which is saved in chronological order for allowing a system auditor to trail the contents of processes of the control device of the centrifuge, or the processes, and is also referred to as operation history information. An item “MACHINE NUMBER” 401 of the audit trail data 400 represents the identification number of the centrifuge 1. Here, as the item “MACHINE NUMBER” 401, a number “0001” representing that the centrifuge is the first one has been stored. However, a specific number which is a combination of information representing which group the corresponding centrifuge of the centrifuges 1 connected in the network as shown in FIG. 4 belongs to, what number the corresponding centrifuge is in the corresponding group, and the like may be additionally given, or as long as the item “MACHINE NUMBER” 401 is set such that it is possible to identify the individual centrifuges 1, any other number can be assigned by another method. Also, the number of digits (bits) to be assigned as a data area for the item “MACHINE NUMBER” 401 is arbitrary. As an item “MANAGEMENT NUMBER” 402, an unambiguous serial number (a so-called journal number) is given for recording in chronological order in the databases. Here, the serial numbers of the audit trail data 400 and the operation parameter data 450 (to be described below) may be collectively managed, or a serial number of only the audit trail data 400 and a serial number of the operation parameter data 450 are independently given. The number of digits of the item “MANAGEMENT NUMBER” 402 is arbitrary. Also, the audit trail data 400 may be generated without giving the item “MANAGEMENT NUMBER” 402.

An item “DATA GENERATION DATE AND TIME” 403 represents the date and time of generation of the audit trail data 400, and in the item “DATA GENERATION DATE AND TIME” 403, the year, month, day, hour, minute, and second of the generation are stored. Here, the date and time data may be more minutely recorded in time units smaller than a second, for example, in units of 10 milliseconds. An item “OPERATOR” 404 represents a user name operating the centrifuge 1. This user name is input in advance from the operation panel 210. An item “OPERATION ITEM” 405 includes data represents the name of an item operated by the user. Here, the item “OPERATION ITEM” 405 shows that rotation speed change corresponding to an operation number “01” has been performed. An item “OPERATION CONTENTS” 406 represents the contents of the operation performed by the user. The audit trail data 400 shows that an operator “AAAA” performed rotation speed change, defined by the operation number “01” stored in the item “OPERATION ITEM”, on the centrifuge having the machine number 0001 at 13:46:13 on Sep. 25, 2012, and the operation contents was change of the rotation speed from 4,000 rpm to 35,000 rpm.

FIG. 8 shows an example of the operation parameter data 450. An item “MACHINE NUMBER” 451 represents the identification number of the centrifuge 1, and the item “MACHINE NUMBER” 451 and an item “MANAGEMENT NUMBER” 452 are given according to the same rules as those for the audit trail data 400 of FIG. 7. Here, as the item “MACHINE NUMBER” 451, a number “0001” representing that the centrifuge is the first one has been stored, and whenever the operation parameter data 450 is generated, as the item “MANAGEMENT NUMBER” 452, an unambiguous management number is given such that the item “MANAGEMENT NUMBER” 452 can be managed collectively with the item “MANAGEMENT NUMBER” 402 of the audit trail data 400. An item “DATA GENERATION DATE AND TIME” 453 represents the date and time of generation of the operation parameter data 450, and in the item “DATA GENERATION DATE AND TIME” 453, the year, month, day, hour, minute, and second of the generation are stored. An item “OPERATOR” 454 represents a user name operating the centrifuge 1. Items 455 to 460 include data representing the state of the centrifuge 1 (having the machine number “0001”) at the data generation date and time stored in the item “DATA GENERATION DATE AND TIME” 403. The example of FIG. 8 represents that at 15:26:53 on Sep. 25, 2012, the operator of the centrifuge having the machine number “0001” was an operator “AAAA”, an item “ROTATION SPEED” 455 represented 35,000 rpm, an item “ROTOR TEMPERATURE” 456 represented 4.2° C., an item “OPERATION TIME” 457 represented that the centrifuge had operated for 1 hour 42 minutes after start, an item “DEGREE OF VACUUM” 458 represented 22 Pa, an item “OPERATION STATUS” 459 represented a code “20” representing that the centrifuge was being set, and an item “ALARM STATUS” 460 represented a code “00” representing that there was no alarm. Data which is stored in the operation parameter data 450 is not limited to those shown in FIG. 8. Data representing other operation statuses may be added.

In the present illustrative embodiment, the operation parameter data 450 is generated at predetermined intervals, for example, at intervals of 10 seconds. However, intervals at which operation parameter data 450 is generated may be any other fixed intervals, or may be arbitrarily changed by an operation of an operator on the operation panel 210. Also, it is preferable that the audit trail data 400 and the operation parameter data 450 which are generated if a user performs a specific operation, for example, an operation for login, logout, rotation start, rotation stop, or change of temperature setting should be generated in parallel, not alternatively.

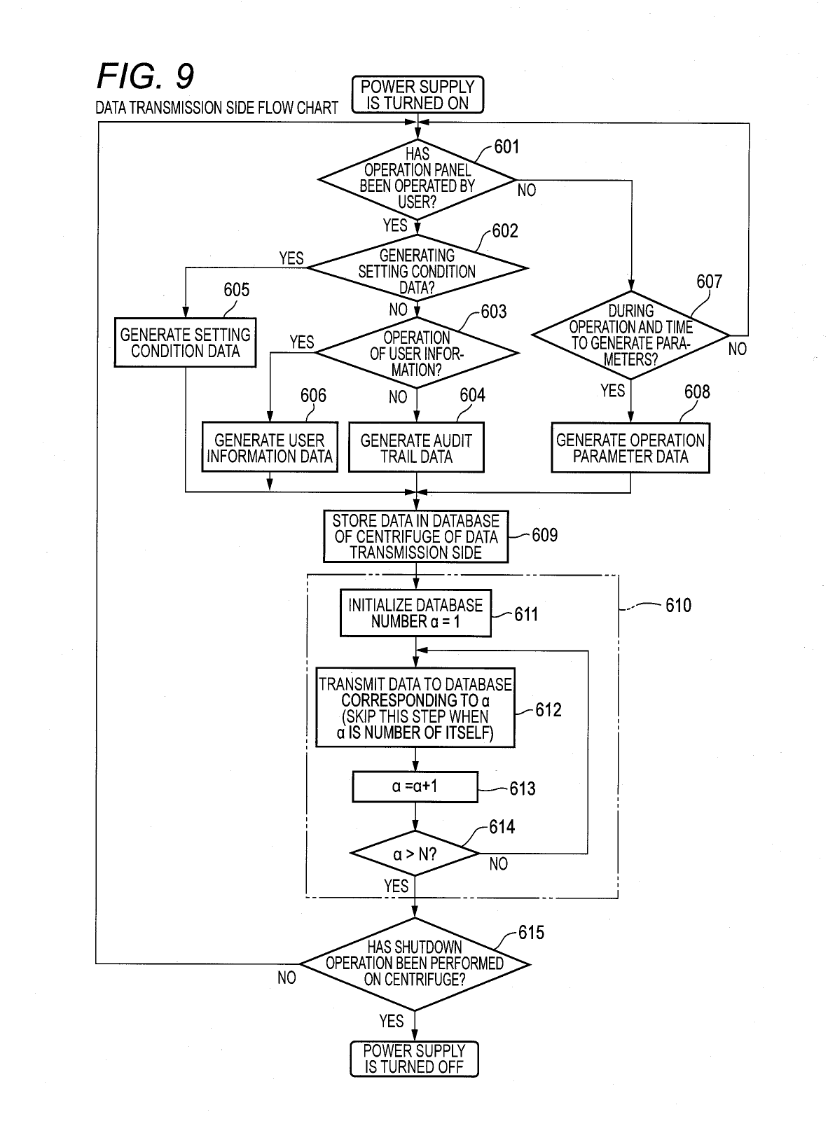

Subsequently, a procedure in which a centrifuge according to the illustrative embodiment of the present invention generates, stores, and transmits the audit trail data 400, the operation parameter data 450, the setting condition data 500, and the user information data 550 will be described with reference to FIG. 9. Here, a procedure in which the centrifuge 1-11 transmits the data to the other centrifuges 1-12 to 1-1n will be described as an example. A flow chart shown in FIG. 9 can be performed by a control device 201 included in each centrifuge 1. For example, a central processing unit 202 included in a control device 201 can execute a computer program (not shown), thereby using software to implement the flow chart of FIG. 9. Control shown in the flow chart of FIG. 9 automatically starts if the power supply of the centrifuge 1 is turned on, and is continued until the power supply is turned off. First, in STEP S601, the central processing unit 202 determines whether a user has operated the operation panel 210. In a case where it is determined that an operation has been performed, in STEP S602, the central processing unit 202 determines whether the operation is inputting of data for common setting conditions. In a case where the operation is inputting of data for common setting conditions, in STEP S605, the central processing unit 202 generates data of the setting condition data 500. Otherwise, the central processing unit 202 proceeds to STEP S603. In STEP S603, the central processing unit 202 determines whether the operation of the user is an operation for user information (registering, editing, or deleting of user information). In a case where the operation of the user is an operation for user information, in STEP S606, the central processing unit 202 generates the corresponding data. In a case where it is determined in STEP S603 that the operation of the user is not an operation for generating user information data, in STEP S604, the central processing unit 202 acquires a current date and time from an internal clock, and updates the item “MANAGEMENT NUMBER” 402, and acquires the information of the items “OPERATOR” 404, “OPERATION ITEM” 405, and “OPERATION CONTENTS” 406, and generates the audit trail data 400.

In a case where it is determined in STEP S601 that there is no operation of the user, the central processing unit 202 proceeds to STEP S607 in which it determines whether it has become a predetermined time to generate the operation parameter data 450. The predetermined time is set, for example, in intervals of 10 seconds. However, in some cases, it is possible to decrease or increase the time intervals. Here, since it is unnecessary to acquire the operation parameter data 450 in a state where both of the rotor 103 and the cooling device (not shown) are stopped, it is preferable to acquire the operation parameter data 450 only when the power supply of the centrifuge is on and any one of the rotor 103 and the cooling device is operating. In a case where it is determined in STEP S607 that it has become the predetermined time to generate the operation parameter data 450, in STEP S608, the central processing unit 202 acquires a current date and time from the internal clock, and updates the item “MANAGEMENT NUMBER” 452, and generates the operation parameter data 450.

If generating the setting condition data 500, the user information data 550, the audit trail data 400, or the operation parameter data 450 in STEP S605, S606, S604, or S608, in STEP S609, the central processing unit 202 stores the generated data in the storage device 203 included in the control device 201 of the centrifuge 11-1. At this time, if an external storage device (not shown) is connected to the USB connector 208 or a memory card terminal (not shown) of the centrifuge 1, the generated data may also be recorded in the external storage device. Alternatively, in STEP S609, only in a case where the residual amount of the storage area of the storage device 203 is insufficient, the generated data may be stored in the external storage device. This storing causes a database including records of a variety of data to be made in the storage device 203 of the centrifuge 11-1.

Subsequently, in the present illustrative embodiment, in STEP S610 for transmission, the central processing unit 202 transmits the generated data to the other centrifuges 1-12 to 1-1n. In STEP S610 for transmission, first, in order to initialize a database number Dα, in STEP S611, the central processing unit 202 substitutes 1 in α. Next, in STEP S612, the central processing unit 202 transmits the audit trail data 400 and the operation parameter data 450 to a centrifuge 1-1α having the database number Dα. During this transmission, the central processing unit 202 uses, for example, an IP address to designate a transmission address, and transmits the data to the centrifuge 1-1α. If this transmission is completed, the central processing unit 202 adds 1 to the database number a in STEP S613, and then determines whether the database number a is larger than N, in STEP S614. In a case where the database number a is not larger than the number N of the final centrifuge 1, the central processing unit 202 repeats the processes of STEPS S612 to S614. Also, in a case where α in STEP S612 is the number (here, 1) of the centrifuge 1-11 which is the transmission side, since the data has already stored in the database D1 of the centrifuge 1-11, the central processing unit 202 skips STEP S612, and proceeds to STEP S613. Also, in a case where it is impossible in STEP S612 to transmit the data to the designated other centrifuge 1-1α, for example, a case where the power supply of the centrifuge 1-1α which is the transmission destination is off, or a case where a time-out has occurred due to a network failure, the central processing unit 202 may skip the process of STEP S612, and proceed to STEP S613.

In STEP S614, a of the database number Dα larger than N means that the data (the setting condition data 500, the user information data 550, the audit trail data 400 or the operation parameter data 450) which needs to be transmitted to a predetermined number of external centrifuges has been completely transmitted. Therefore, in STEP S615, the central processing unit 202 determines whether a shutdown operation has been performed on the centrifuge 1-11. If it is determined that a shutdown operation has not been performed, the central processing unit 202 returns to STEP S601. Meanwhile, in a case where it is determined that a shutdown operation has been performed, since the power supply has been turned off due to the shutdown operation, the central processing unit 202 finishes the procedure of the processes of FIG. 9.

As described above, according to the present illustrative embodiment, each centrifuge records settings for a centrifuging operation, or information related to operation records, in itself, and transmits the settings or the operation record information to each external centrifuge 1 such that the settings or the operation record information is stored in the corresponding external centrifuge. Therefore, it is possible to reliably store the settings or the operation record information without omission. Also, in the present illustrative embodiment, in STEP S608 for transmission to any other centrifuge 1, the transmission side centrifuge performs one-to-one communication with each other centrifuge 1, thereby transmitting and receiving necessary data. However, the transmission side centrifuge may broadcast information in the network 900, thereby transmitting the information to the other centrifuges 1 at the same time. Further, in order to improve confidentiality of information, data to be transmitted and received between a plurality of centrifuges may be encrypted by a known encryption technology, and then be transmitted.

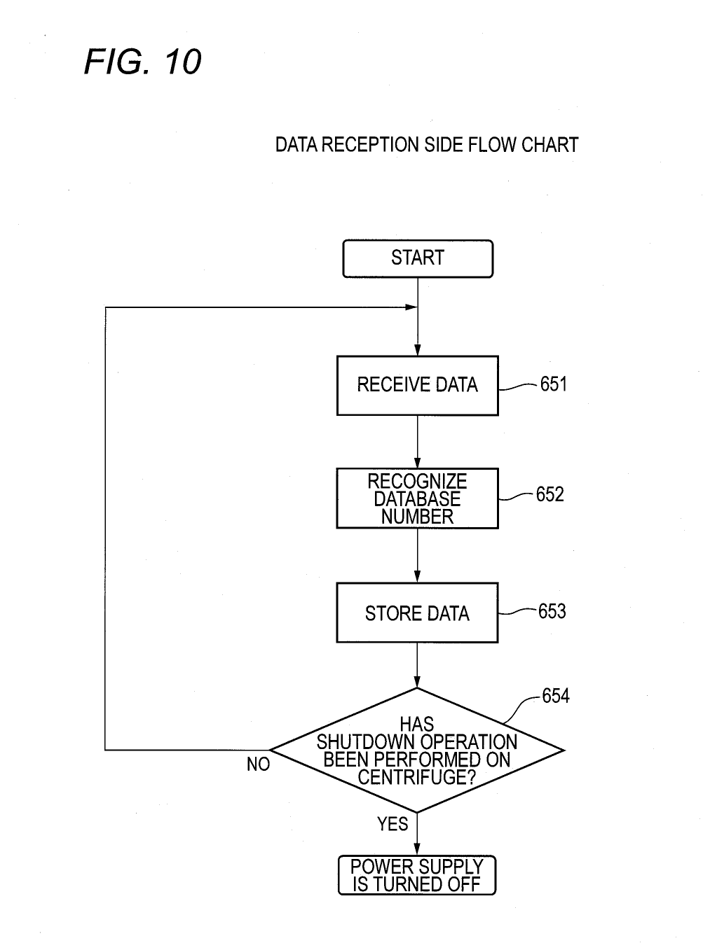

Subsequently, a procedure in which a centrifuge according to the illustrative embodiment of the present invention receives and stores the audit trail data 400 and the operation parameter data 450 will be described with reference to FIG. 10. A flow chart shown in FIG. 10 can also be implemented by software, and is performed in parallel with the program of FIG. 9 by a control device 201 included in each centrifuge 1. The procedure of FIG. 10 automatically starts if the power supply of a centrifuge 1 is turned on, and finishes if the power supply is shut down. If the power supply of a centrifuge 1 is turned on, the communication I/F 204 automatically becomes capable of receiving data through the network 900. If data is received in STEP S651, in STEP S652, the central processing unit 202 analyzes the received data, and determines which centrifuge 1 has transmitted the data, with reference to information included in the received data, thereby recognizing a database number for storing. Subsequently, in STEP S653, the central processing unit 202 stores the received data in reference number order in a storage area corresponding to the identified database number and included in the storage device 203. In this case, all of the received data may be stored in the storage device 203, or only specific data (for example, only the audit trail data 400) may be selectively stored. Subsequently, in STEP S654, the central processing unit 202 determines whether a shutdown operation has been operated on the centrifuge 1. If it is determined that a shutdown operation has not been performed, the central processing unit 202 returns to STEP S651, and repeats the same processes. Meanwhile, in a case where it is determined in STEP S654 that a shutdown operation has been performed, since the power supply has been turned off due to the shutdown operation, the central processing unit 202 finishes the procedure of the processes of FIG. 10. While the power supply is on, the centrifuge 1 performs the processes of FIG. 10, thereby always receiving data transmitted from any other centrifuge 1, and automatically recording the received data. Therefore, it is unnecessary to prepare a server apparatus for every two or more centrifuges 1, and it is possible to redundantly store data without any server apparatuses.

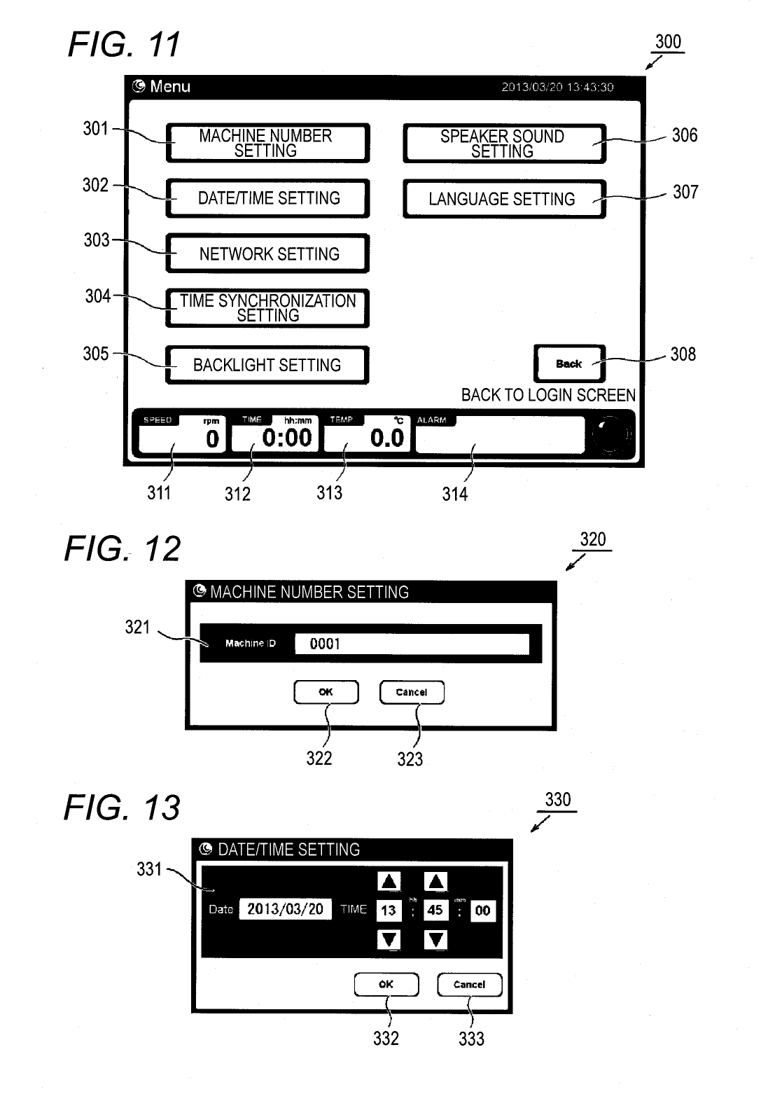

FIG. 11 shows an example of a menu screen 300 which is displayed on an operation panel 210 and allows a user to perform a variety of settings. On the menu screen 300, a variety of menu icons such as an icon “MACHINE NUMBER SETTING” 301, an icon “DATE/TIME SETTING” 302, an icon “NETWORK SETTING” 303, an icon “TIME SYNCHRONIZATION SETTING” 304, an icon “BACKLIGHT SETTING” 305, an icon “SPEAKER SOUND SETTING” 306, and an icon “LANGUAGE SETTING” 307 are displayed. From this menu screen 300, a user selects an object to be operated. In a portion of the menu screen 300, for example, in a lower portion of FIG. 11, the current states of the centrifuge 1, that is, the rotation speed 311, the elapsed time 312 of the operation, and the temperature 313 of the rotor 103 are displayed. Also, in a case where there is any message, in an alarm section 314, the contents of the message is displayed. As described above, even when the menu screen 300 is being displayed, the current operation states of the centrifuge and a message can be displayed in a portion of the menu screen. Therefore, while operating the menu screen 300, the user can surely monitor the operation status of the centrifuge 1.

FIG. 12 shows a screen which is displayed if the icon “MACHINE NUMBER SETTING” 301 is selected in FIG. 11. If the icon “MACHINE NUMBER SETTING” 301 is selected, switching from the menu screen 300 to a machine number setting screen 320 is performed, or the machine number setting screen 320 pops up on the menu screen 300 such that the user can input an arbitrary number to a machine number input section. Then, the user touches the machine number (machine ID) section 321 such that a ten key screen (not shown) is displayed, and inputs a machine number, and closes the ten key screen, and then touches an OK icon 322, thereby confirming the machine number. In a case where the user does want to confirm the machine number, or in a case where the user wants to cancel the input operation, if the user touches a cancel icon 323, returning to the menu screen 300 of FIG. 11 is performed.

FIG. 13 shows a screen which is displayed if the icon “DATE/TIME SETTING” 302 is selected in FIG. 11. If the icon “DATE/TIME SETTING” 302 is selected, switching from the menu screen 300 to a date/time setting screen 330 is performed, or the date/time setting screen 330 pops up on the menu screen 300, such that the user can set a date and a time. Then, the user touches a date/time section 331, and inputs numbers, and then touches an OK icon 332, thereby confirming the date and the time. In a case where the user does want to confirm the date and the time, or in a case where the user wants to cancel the input operation, if the user touches a cancel icon 333, returning to the menu screen 300 of FIG. 11 is performed. Also, since the centrifuge 1 of the present illustrative embodiment is connected to the network 900, the date and the time may be automatically acquired from the network, instead of being set by the user. Further, the control device 201 may include a so-called atomic clock which receives a standard wave and automatically corrects an error.

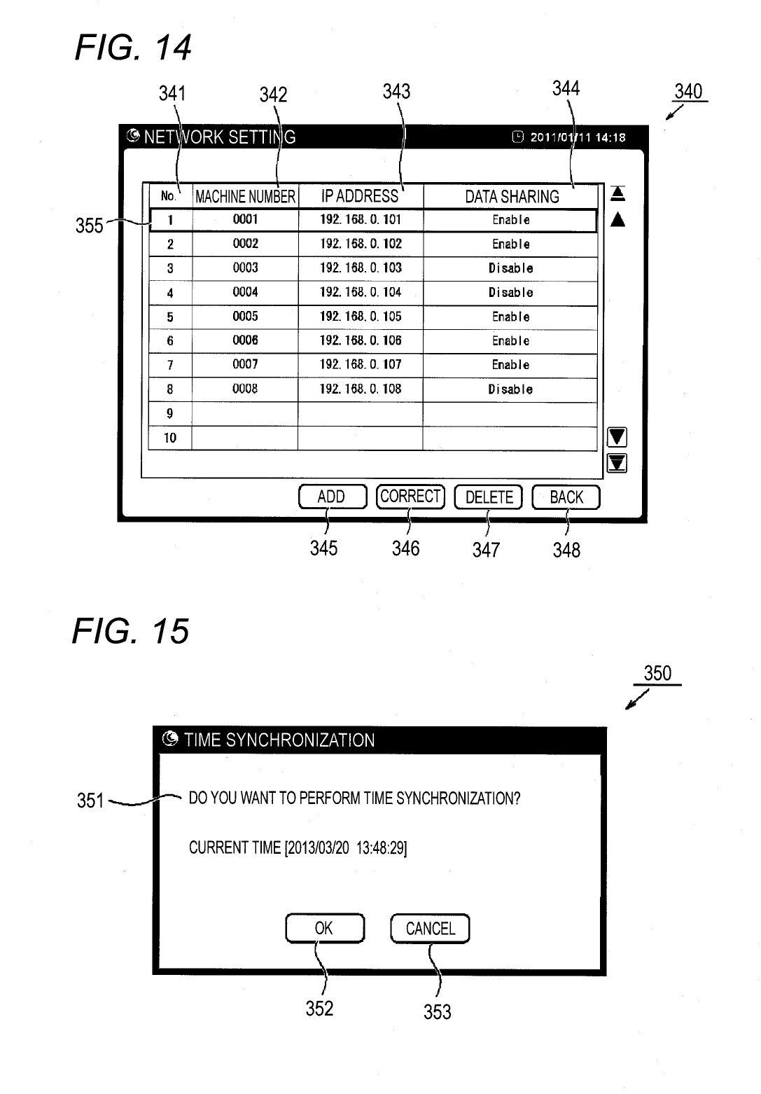

FIG. 14 shows a screen which is displayed if the icon “NETWORK SETTING” 303 is selected in FIG. 11. If the icon “NETWORK SETTING” 303 is selected, switching from the menu screen 300 to a network setting screen 340 is performed, or the network setting screen 340 pops up on the menu screen 300. Therefore, with respect to all centrifuges connected to the network, it is possible to individually determine whether to perform sharing of operation data (“Enable”) or not (“Disable”). With respect to each centrifuge for which it is determined to perform sharing of operation data (each database for which “Enable” has been set), in STEP S609 of FIG. 9, the data is transmitted, and in STEP S653 of FIG. 10, the received data is stored in the database. In the network setting screen 340, an item “SERIAL NUMBER” 341 and an item “MACHINE NUMBER” 342 are displayed, and an item “IP ADDRESS” 343 corresponding to them are displayed. The items “SERIAL NUMBER” 341 and “IP ADDRESS” 343 may be automatically set by a network server (not shown), a router, or the like. A data sharing section 344 is individually set by a user having authority to change, and thus it is possible to set whether to perform data sharing for each machine number. Here, “Enable” represents that it is determined to perform data sharing. Therefore, operation data is transmitted to and received only between centrifuges 1 having machine numbers for which “Enable” has been set. Here, with respect to a number “1” of the item “SERIAL NUMBER” 341, information on a centrifuge 1 which the user is operating is displayed and is surrounded by a thick frame 355. In a case where the user desires to perform additional inputting, the user can click an add icon 345, and newly input values in the section of a serial number “9”. Also, the user can select a specific row, and click a correct icon 346, and then correct the contents of the input items. Also, the user can select a specific row, and click a delete icon 347, and then delete registration of an arbitrary item of the list. A back icon 348 is an icon for finishing the input setting of the list and returning to the screen of FIG. 11.

FIG. 15 shows a screen which is displayed if the icon “TIME SYNCHRONIZATION SETTING” 304 is selected in FIG. 11. If the icon “TIME SYNCHRONIZATION SETTING” 304 is selected, a time synchronization screen 350 is displayed. Here, data on a current time is acquired from an external device which is a reference, and in a display section 351, the current time is displayed together with an inquiry “DO YOU WANT TO PERFORM TIME SYNCHRONIZATION?”. If the user is satisfied with the displayed time, the user touches an OK icon 352, whereby the time information is transmitted to centrifuges for which it has been set to perform sharing of operation data (“Enable”) in FIG. 14, and a time synchronization process is performed. In a case where the user does not desire to perform the time synchronization process, the user touches a cancel icon 353. Here, the external device from which the current time is acquired may be an external server, or may be a centrifuge (a master) which is one of the plurality of centrifuges 1 and is a reference. As described above, operation data which are stored in the databases include the machine numbers of the centrifuges 1 and the dates and times of generation of the operation data as described in the audit trail data 400 and the operation parameter data 450, and these times are synchronized. Therefore, management of data based on the databases is easy.

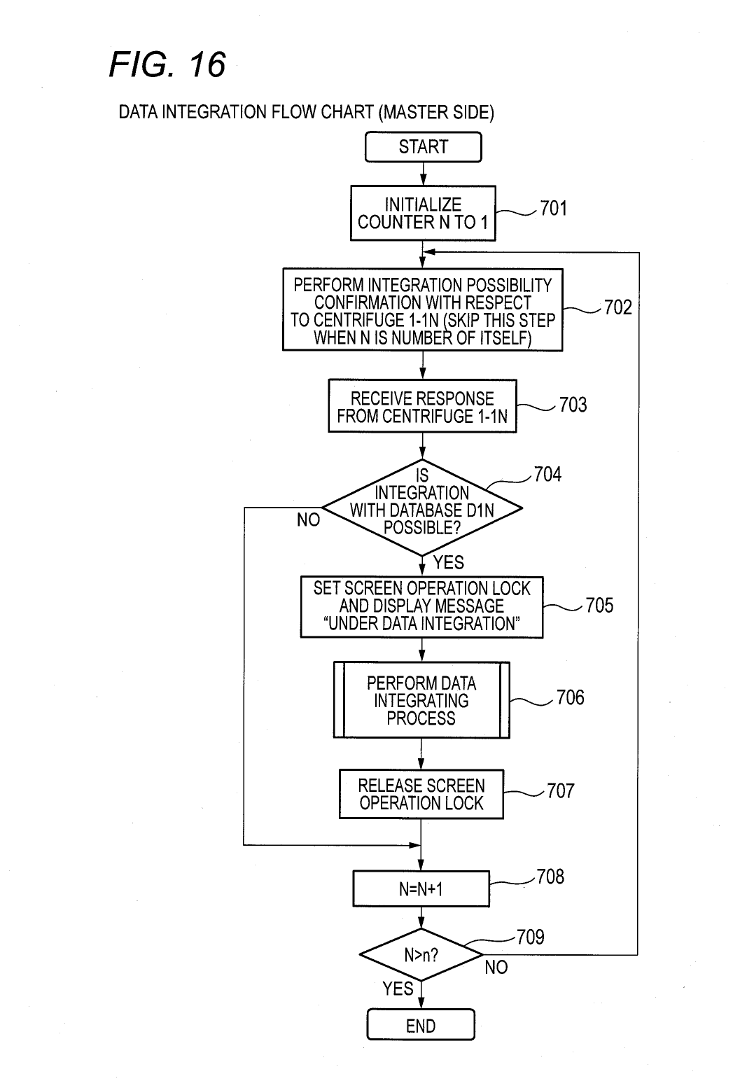

Subsequently, an operation data integrating process of the present illustrative embodiment will be described with reference to FIGS. 16 to 18. In the present illustrative embodiment, the operation data of a specific centrifuge 1 (here, a centrifuge 1-11) is stored in the storage device 203 of the specific centrifuge 1-11, and is transmitted to the other centrifuges 1 (here, the centrifuges 1-12 to 1-1n) such that the operation data is stored in the other centrifuges 1. Here, an issue is whether the power supply of each of the other centrifuges 1 is on. Each centrifuge 1 is not necessarily on, and is powered on or off as necessary by a user. Therefore, a centrifuge 1 which is off, that is, which is stopped cannot receive operation data transmitted from any other centrifuge 1. Under these circumstances, it is important to determine whether there is operation data which could not be received due to turning-off of the power supply, and receive unreceived operation data, and integrate the received operation data with the data stored in a database, such that the data stored in the database becomes complete. Here, in some cases such as a case where a centrifuge 1 is not centrifuging, or a case where the processing capability of the control device 201 of a centrifuge 1 is sufficient even if the centrifuge 1 is centrifuging, the centrifuge 1 checks existence or non-existence of unreceived operation data and performs an integrating process of adding difference data to the received operation data. In the present illustrative embodiment, a case where the centrifuge 1-11 performs a data integrating process of performing integration with the other centrifuges 1-12 to 1-1n belonging to Group 1 will be described as an example.

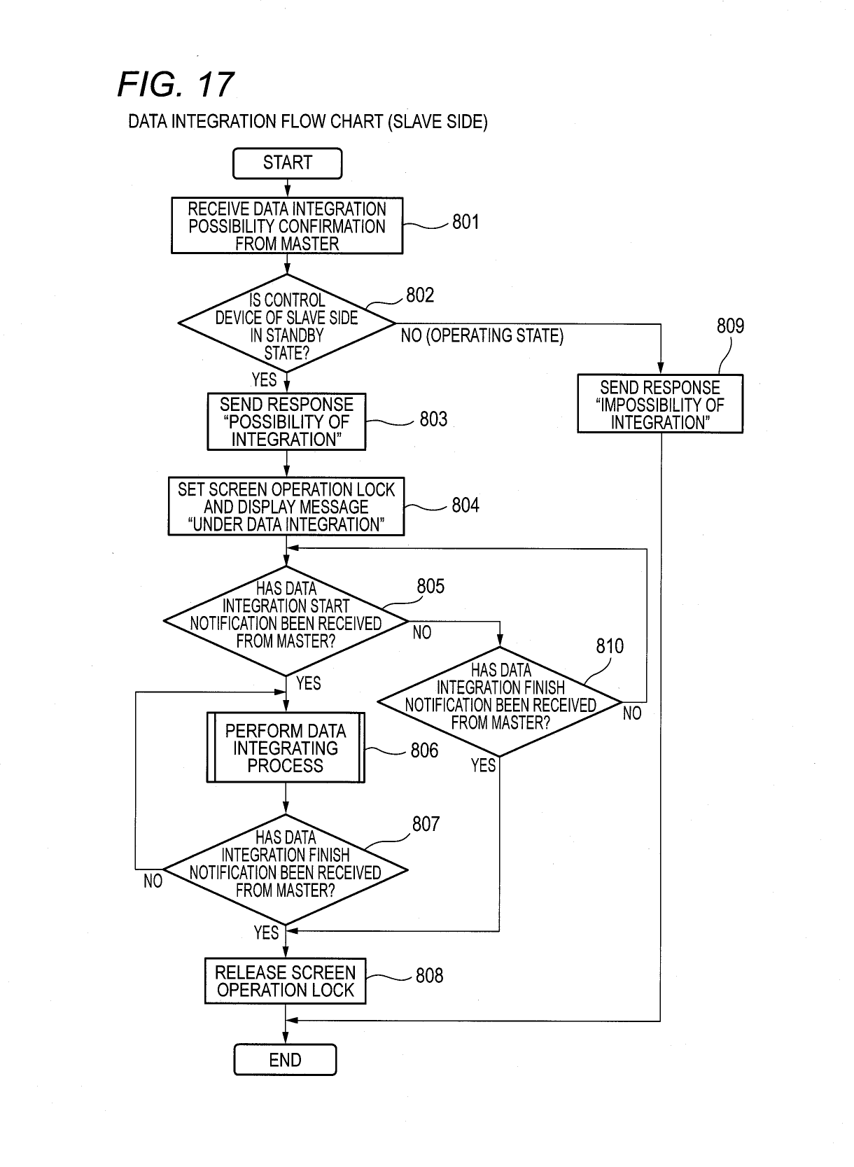

FIG. 16 is a flow chart illustrating a procedure of a data integrating process which is performed on the control device (201) side of the centrifuge 1-11 which is the master side. First, in STEP S701, the control device 201 performs initialization of data of a counter N for setting the number of any other centrifuge to be first connected. Next, in STEP S702, the control device 201 performs integration possibility confirmation of inquiring about whether it is possible to perform an integrating process, with respect to a centrifuge 1-1N through the network 900. Next, in STEP S703, the control device 201 receives a response to the integration possibility confirmation from the centrifuge 1-1N. At this time, it may be impossible to receive a response to the integration possibility confirmation due to turning-off of the power supply of the centrifuge 1-1N. In this case, if a time-out time elapses, the control device 201 proceeds to STEP S704. In STEP S704, the control device 201 determines whether it is possible to integrate data with a database DIN, on the basis of the response from the centrifuge 1-1N. In a case where it is possible to integrate data with the database D1N, in STEP S705, the control device 201 of the centrifuge 1-11 of the master side stops operation inputting on the operation panel 210 for preventing the operation panel 210 from being operated by a user, and displays a message “UNDER DATA INTEGRATION” on a screen. Thereafter, in STEP S706, the control device 201 performs a data integrating process between the centrifuge 1-11 and the centrifuge 1-1N through the network 900. The detailed procedure of the data integrating process of the STEP S706 will be described below with reference to FIG. 17. If the data integrating process of STEP S706 finishes, in STEP S707, the control device 201 releases the screen operation lock such that the user can perform operation inputting on the operation panel 210, and deletes the display “UNDER DATA INTEGRATION”. Thereafter, the control device 201 proceeds to STEP S708.

In a case where it is determined in STEP S704 that a response representing that integration is impossible has been received from the centrifuge 1-1N, or in a case where a time-out has occurred without receiving any response from the centrifuge 1-11, the control device 201 proceeds to STEP S708. In STEP S708, the control device 201 increments the value of the counter N. If the value of the counter N is larger than n which is the final number, since the integrating process with all of the other centrifuges 1 which are objects has been completed, the control device 201 finishes the process. Meanwhile, if the value of the counter N is not larger than n, the control device 201 returns to STEP S702, and repeats the processes of STEPS S702 to S708.

Subsequently, a procedure of a data integrating process which is performed by the centrifuge 1-1N (for example, the centrifuge 1-12) of the slave side when the procedure of the data integrating process of FIG. 16 is performed will be described with reference to the flow chart of FIG. 17. The process of FIG. 17 can be performed by the control device 201 of each centrifuge 1 of the slave side. Every centrifuge 1 on the master side and the slave side can receive data from any other centrifuge through the network 900 when its power supply is on. First, if receiving a data integration possibility confirmation notification from the centrifuge 1-11 of the master side in STEP S801, in STEP S802, the control device 201 of the slave side determines whether the control device 201 is in a standby state. Here, the standby state means a light load state which does not correspond to any of a case where any other arithmetic process is being performed and thus capability to perform the data integrating process is insufficient and a case where centrifuging is being performed and thus a load on the control device 201 is high. In a case where it is determined in STEP S802 that the control device 201 of the slave side is not in a standby state, in STEP S809, the control device 201 sends a response “IMPOSSIBILITY OF INTEGRATION” representing that it is impossible to perform the integrating process, to the master side. Then, the control device 201 finishes the process of the slave side.

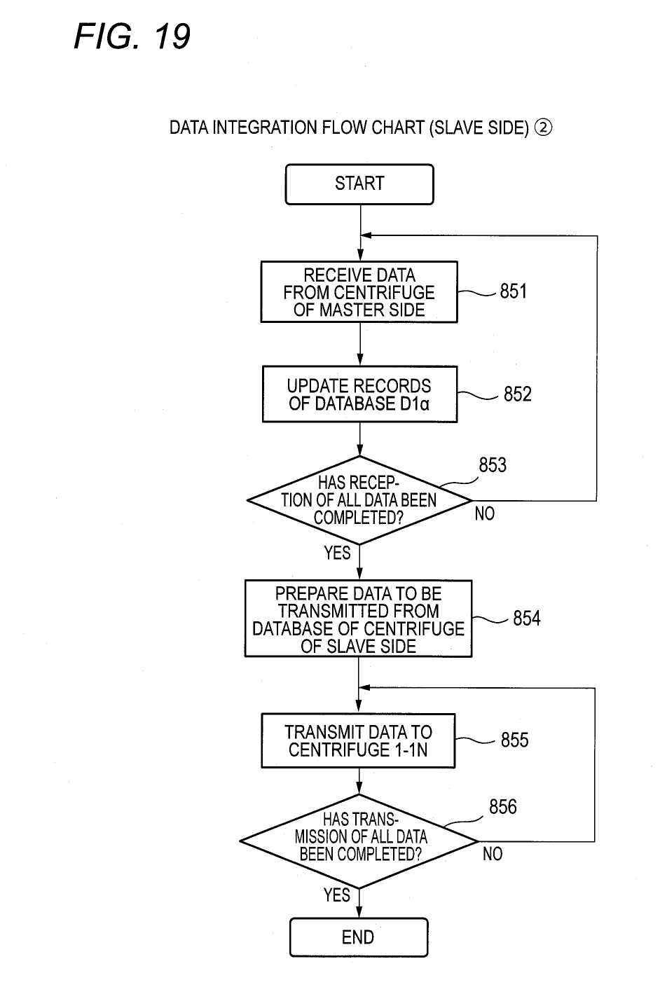

In a case where it is determined in STEP S802 that the control device 201 is in the standby state, in STEP S803, the control device 201 sends a response “POSSIBILITY OF INTEGRATION” representing that it is possible to perform the integrating process, to the centrifuge 1-11 of the master side. Next, in STEP S804, the control device 201 sets screen operation lock for prohibiting operation inputting of a user on the operation panel 210, and perform a display representing “UNDER DATA INTEGRATION” on the operation panel 210 of the centrifuge 1-1N. Subsequently, in STEP S805, the control device 201 determines whether a data integration start notification has been received from the master centrifuge. In a case where a data integration start notification has been received, in STEP S806, the control device 201 starts the data integrating process. The detailed procedure of the data integrating process will be described below with reference to FIG. 19. The control device 201 repeats the data integrating process until a data integration finish notification is received from the master side (STEP S807). Meanwhile, in a case where it is determined in STEP S805 that a data integration start notification has not been received from the master centrifuge, in STEP S810, the control device 201 determines whether a data integration finish notification has been received. In a case where a data integration finish notification has been received, the control device 201 proceeds to STEP S808; whereas in a case where any data integration finish notification has not been received, the control device 201 returns to STEP S805. In STEP S808, the control device 201 releases the screen operation lock such that the user can perform operation inputting on the operation panel 210, and deletes the display representing “UNDER DATA INTEGRATION”.

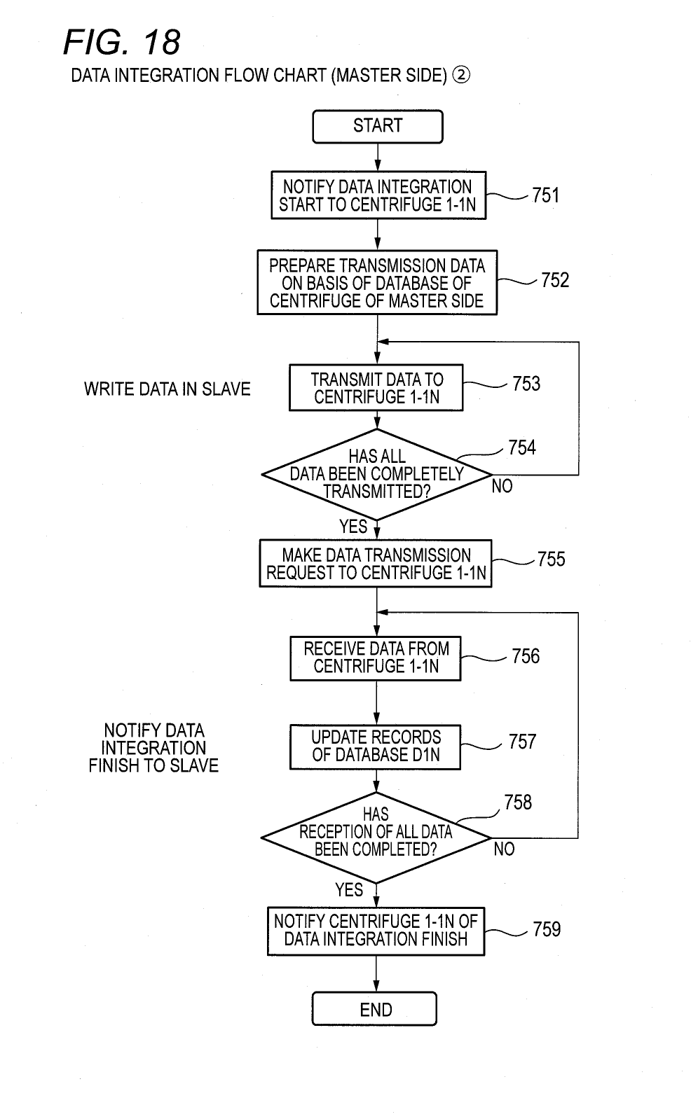

Subsequently, the detailed procedure of the data integrating process of STEP S706 of FIG. 16 will be described with reference to the flow chart of FIG. 18. The process of FIG. 18 is a process which is performed by the control device 201 of the centrifuge 1 (for example, the centrifuge 1-11) of the master side. First, in STEP S751, the control device 201 notifies data integration start to the centrifuge 1-1N (for example, the centrifuge 1-12) of the slave side. Next, in STEP S752, on the basis of the data stored in the database Dα (here, α is 1) of the centrifuge 1, the control device 201 prepares data to be transmitted to the database of the slave side. Here, it is preferable to record how much data has been transmitted to each centrifuge 1-1N and how much data has been received, on the master side and the slave side, such that the next data of the transmitted data is transmitted. Next, in STEP S753, the control device 201 transmits the data to the centrifuge 1-1N (here, N is 2) of the slave side. The transmission data is untransmitted portions of the setting condition data 500, the user information data 550, the audit trail data 400, and the operation parameter data 450. If it is determined in STEP S754 that all untransmitted data has been completely transmitted, in STEP S755, the control device 201 makes a data transmission request to the centrifuge 1-1N of the slave side. On the occasion of the transmission request, it is preferable to transmit a list of identification information of data items of the master side, thereby informing the slave side about which data has been received. Next, the control device 201 receives data from the centrifuge 1-1N in STEP S756, and updates the records of the database DIN (here, N is 1) in STEP S757. Then, the control device 201 repeats STEPS S756 and S757 so as to receive unreceived data until reception of all data is completed (STEP S758). If reception of all unreceived data of the data is completed, the control device 201 notifies the centrifuge 1-1N of the slave side about data integration finish, in STEP S759, and finishes the present process.

Subsequently, the detailed procedure of the data integrating process of STEP S806 of FIG. 17 will be described with reference to the flow chart of FIG. 19. The process of FIG. 19 is a process which is performed by the control device 201 of the centrifuge 1-1N (here, N is 2) of the slave side, and is performed at the same time as the procedure according to the flow chart of FIG. 18. First, in STEPS 5851, the centrifuge 1-1N of the slave side receives the data from the centrifuge 1-11 of the master side. Next, in STEP S852, the control device 201 updates the records stored in a database D1α (here, α is 2). The control device 201 repeats the process of STEP S852 until reception of all data transmitted from the centrifuge 1-11 of the master side is completed (STEP S853). Next, in STEP S854, the control device 201 prepares data to be transmitted from the database D1α (here, α is 2) of the slave side to the database of the master side. Next, in STEP S855, the control device 201 transmits the data to the centrifuge 1-11 of the master side. The transmission data is untransmitted portions of the setting condition data 500, the audit trail data 400, and the operation parameter data 450 related to the centrifuge 1-1N of the slave side. If it is determined in STEP S856 that transmission of all untransmitted data has been completed, the control device 201 finishes the process. Also, in a case of instructing deletion of unnecessary data in the specific centrifuge 1 (here, the centrifuge 1-11), the same data in any other centrifuge (the centrifuge 1-1n) may be automatically deleted.

As described above, if the flow charts shown in FIGS. 16 to 19 are performed when the centrifuges 1 of the master side and the slave side are not operating, or when processing loads due to the control devices 201 are low even if the centrifuges 1 are operating, it is possible to multiply save the latest data related to the plurality of centrifuges 1. Also, since setting conditions for centrifuging operations are multiply saved, particularly, in a case of operating a centrifuge of the slave side, settings of operation conditions are completed only by calling the set operation conditions of the master side. Therefore, it is user-friendly, and it is possible to significantly reduce the fear of mistakes in settings of operation conditions. Also, with respect to the data storing method of multiply storing data in the plurality of centrifuges 1, many variations can be considered. For example, when the plurality of centrifuges 1 is connected in Group 1, it is unnecessary to store all data in all of the plurality of centrifuges, and as triple recording of data, the data may be stored only in the centrifuge 1 of the master side and any other two centrifuges 1. Also, even in the case of this triple recording, it is preferable to store only the setting condition data 500 and the user information data 550 in all centrifuges 1.

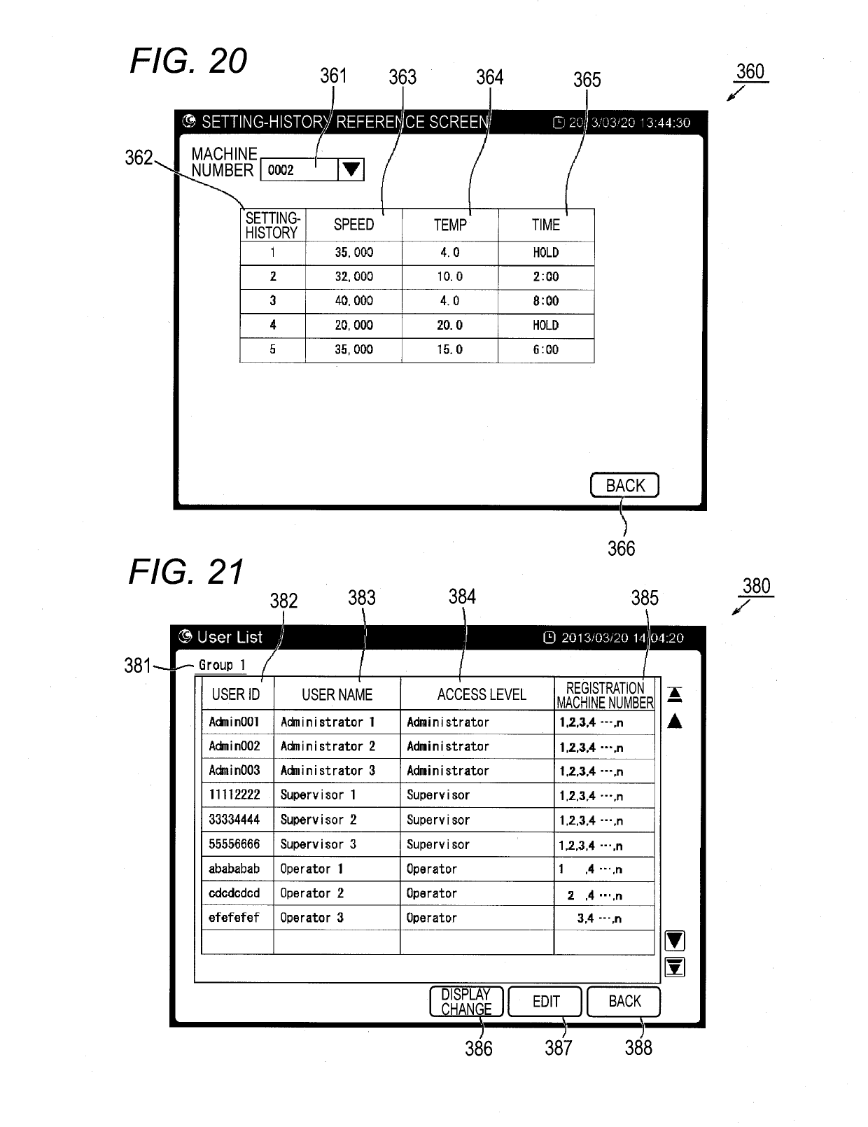

FIG. 20 illustrates a method of browsing the operation history of any other centrifuge 1, and after a setting-history reference screen 360 (not shown) is displayed on the operation panel 210, it is possible to confirm the past operation history of a desired other centrifuge. For example, if the user operates the operation panel 210 of the centrifuge 1-11, thereby inputting the machine number (for example, “0002” in the illustrative embodiment) of a desired other centrifuge 1 to a machine number input section 361, the past operation history of the centrifuge 1-12 corresponding to the input machine number is displayed. The displayed contents are, for example, an item “SETTING-HISTORY NUMBER” 362, an item “SET ROTATION SPEED” 363, an item “SET TEMPERATURE” 364, and an item “SET OPERATION TIME” 365. Further, in a case where the user desires to use the past operation history of the displayed other centrifuge (whose machine number is 2) to operate the centrifuge 1 having a machine number “1”, the user may touch the displayed operation history, such that the operation conditions of the displayed operation history are set as operation conditions of the machine number “1”. Also, the user can touch a back button 366, thereby exiting from the setting-history reference screen 360 of the other centrifuge. Also, although FIG. 20 shows an illustrative embodiment in which one other centrifuge is displayed, the past operation histories of all centrifuges in a group may be displayed at once.

FIG. 21 shows a user list screen 380 in which users reregistered in centrifuges 1 belonging to a group (here, Group 1) set in an item “GROUP ID” 381 are integrally displayed. In this screen, an item “USER ID” 382, an item “USER NAME” 383, and an item “ACCESS LEVEL” 384 are displayed, and on the right side of the screen, an item “REGISTRATION MACHINE NUMBER” 385 representing the machine numbers of centrifuges 1 in which each user has been registered. Here, for example, with respect to a user “abababab”, 1, 4, . . . , and n have been set as registration machine numbers. This can be considered as the corresponding user has been registered in the centrifuges 1-11, 1-14, . . . , and 1-1n. As described above, in each centrifuge 1, it is possible to refer to all users registered in one group set in an item “GROUP” 381. Therefore, it is possible to easily construct the user list of the corresponding centrifuge 1 by reusing or copying the contents of the user list screen 380. In this case, only a copying operation is needed to construct a user list. Therefore, even in a case of adding a new centrifuge 1 to centrifuges 1-11 to 1-1N of an existing management group, it is possible to easily perform a registration operation. In order to edit the user list of the corresponding centrifuge from the state of FIG. 21, the user can touch an edit icon 387, thereby performing a transition to a user list editing screen for the corresponding centrifuge. Also, the user can touch a display change icon 386, such that the user list of an arbitrary machine number is displayed. Further, the user can touch a back icon 388, thereby finishing the display of the user list screen 380.

Although the present invention has been described above on the basis of illustrative embodiment, the present invention is not limited to the above described illustrative embodiment, and can be modified in various forms without departing from the scope of the present invention. For example, in the above described illustrative embodiment, each centrifuge 1 is configured using a so-called continuous centrifugal separator. However, each centrifuge 1 may be configured by a general centrifugal separator having a removable rotor, or by a mixture of a continuous centrifugal separator and a general centrifugal separator. Also, the centrifuges may be configured using centrifugal separators having vacuum pumps for evacuating rotor chambers, such that the present invention can be used to record the vacuum states of them.

The present invention provides illustrative, non-limiting aspects as follows:

According to an aspect of the present invention, there is provided a centrifuge including a rotor configured to separate a sample, a driving unit configured to rotate the rotor, a control device configured to control the driving unit, a data generating means configured to generate operation data, a data storage device configured to store the operation data, and a communication unit configured to connect the centrifuge to at least one external centrifuge. In this centrifuge, the control device is configured to generate operation data which is a record of an operation status according to a centrifuging operation, and is configured to store the operation data in its data storage device (a first storage device) and also transmit the operation data to another centrifuge connected through the communication unit such that the operation data is stored in a data storage device (a second storage device) of the other centrifuge. Since the operation data is multiply stored in the corresponding centrifuge and the other centrifuge as described above, it is possible to significantly reduce a risk of data loss. Also, since the other centrifuge is used as an external storage device for redundantly storing, it becomes unnecessary to provide a separate server apparatus or the like. Although the operation data is configured so as to include the identification information of the centrifuge and the date and time of generation of the operation data, it is preferable to give an unambiguous management number such as a journal number or a serial management number such that in a case of storing the operation data in chronological order, it is possible to easily detect data omissions. Since a journal number or a serial management number is given to the operation data and then the operation data is transmitted and received through the communication unit, the reception side can easily recognize existence or non-existence of data omissions, and data management becomes easy.

According to the aspect of the present invention, the storage unit of the centrifuge includes a storage area for storing its own operation data and storage areas for storing operation data transmitted from other centrifuges, such that databases are established for the centrifuges, respectively. Therefore, management and movement of the databases, and access to the databases are facilitated. The operation data includes audit trail data (operation history data) which is generated if the centrifuge is operated by a user, and an operation parameter (operation status record data) which is generated at predetermined intervals during a centrifuging operation. If operation data generated by any other centrifuge is received through the communication unit, the control device stores the received operation data in a predetermined storage area of the storage device of the centrifuge. For this storing, it is preferable to use a transmission source IP address to identify the centrifuge which is the transmission source, and store the operation data in a storage area assigned to the transmission source. Since received data is classified and stored during recording as described above, management and movement of the databases, and access to the databases become very easy.

According to another aspect of the present invention, at predetermined time intervals or in response to each predetermined event, for example, immediately after each activation, the centrifuge collates operation data stored in the storage device with the other centrifuge through the communication unit, and exchanges the operation data, which is missing, with the other centrifuge. Since confirmation of operation data having omissions is performed as described above, it is possible to implement a system which effectively and multiply stores operation data while using centrifuges whose power supply switches may be turned off. Also, the control device may perform a time synchronization process of synchronizing an internal clock with the other centrifuge connected by the communication unit. In this case, an obstacle to data integration due to a time offset can be removed, and it is possible to construct a system which manages operation data of a centrifuge and has high reliability. Also, if a centrifuge for sharing the operation data can be selected and set in advance from a plurality of centrifuges connected by the communication unit, it is possible to implement an operation data managing system capable of appropriately coping with the purposes of centrifuges.

According to another aspect of the present invention, a centrifuge includes a rotor configured to separate a sample, a driving unit configured to rotate the rotor, a control device configured to control the driving unit, and a communication unit configured to connect the centrifuge with an external centrifuge. In this centrifuge, the control device includes a clocking unit, and the control device has a time synchronization function of performing time synchronization with the external centrifuge through the communication unit. Since the time synchronization function is provided, it is possible to synchronize the times of a plurality of centrifuges by a simple operation. Also, the centrifuge may further include a USB connector to which an external storage device is connected such that the control device can store the generated operation data in the external storage device through the USB connector. In this case, since the USB connector is provided, it is possible to easily cope with a case where the centrifuge cannot be connected with the external centrifuge, and a case where the capacity of the storage device of the centrifuge is not sufficient.

According to at least one of the above-described aspects, in addition to storing the operation data generated by the centrifuge in the data storage device of the centrifuge, the operation data is also transmitted to another centrifuge connected through the communication unit such that the operation data is stored in the data storage device of the other centrifuge. Therefore, it is possible to significantly reduce a risk of operation data loss due to a breakdown of the data storage device. Also, even if a network is in an abnormal state such as a disconnected state, since the centrifuge has a built-in data storage device, it is possible to continue an operation without stopping the centrifuge. Further, it is unnecessary to provide an apparatus (for example, a server apparatus) dedicated for data storing. Furthermore, since a centrifuge for sharing the operation data can be selected and set in advance from a plurality of centrifuges connected by the communication unit, it is possible to provide a convenient system capable of excluding an inactive centrifuge.

Further, since the operation data include the individual identification information and/or data and time information of centrifuges, and time synchronization is performed, it is possible to easily perform management and collation of the operation data.

What is claimed is:

1. A centrifuge comprising:
a rotor configured to separate a sample;
a driving unit configured to rotate the rotor;
a control device configured to control the driving unit and generate operation data;
a data storage device configured to store the operation data; and
a communication unit configured to connect the centrifuge with another centrifuge,
wherein the storage device has a first storage area configured to store the operation data of the centrifuge, and a second storage area configured to store operation data of the other centrifuge acquired through the communication unit.

2. The centrifuge according to claim 1,
wherein the operation data includes identification information of the centrifuge, and date and time of generation of the operation data.

3. The centrifuge according to claim 2,
wherein the operation data includes audit trail data which is generated if the centrifuge is operated by a user.

4. The centrifuge according to claim 2,
wherein the operation data includes an operation parameter which is generated at predetermined intervals during a centrifuging operation.

5. The centrifuge according to claim 2,
wherein the operation data is transmitted and received by the communication unit by using an IP addresses assigned to each centrifuge.

6. The centrifuge according to claim 1,
wherein, if operation data generated by the other centrifuge is received through the communication unit, the control device stores the received operation data in the storage device.

7. The centrifuge according to claim 6,
wherein the centrifuge collates the operation data stored in the storage device with the other centrifuge through the communication unit, and exchanges the operation data, which is missing, with the other centrifuge.

8. The centrifuge according to claim 1,
wherein the control device performs a time synchronization process of synchronizing an internal clock with the other centrifuge connected by the communication unit.

9. The centrifuge according to claim 1,
wherein the centrifuge for sharing the operation data can be selected and set in advance from a plurality of centrifuges connected by the communication unit.

10. A centrifuge comprising:
a rotor configured to separate a sample;
a driving unit configured to rotate the rotor;
a control device configured to control the driving unit and generate operation data;
a data storage device configured to store the operation data; and
a communication unit configured to connect the centrifuge with another centrifuge,
wherein the control device is configured to generate operation data which is a record of an operation status according to a centrifuging operation, and
wherein the control device is configured to store the operation data in the data storage device, and transmit the operation data to the other centrifuge connected through the communication unit.

11. The centrifuge according to claim 10,
wherein the operation data includes identification information of the centrifuge, and date and time of generation of the operation data.

12. The centrifuge according to claim 11,
wherein the operation data includes audit trail data which is generated if the centrifuge is operated by a user.

13. The centrifuge according to claim 11,
wherein the operation data includes an operation parameter which is generated at predetermined intervals during a centrifuging operation.

14. The centrifuge according to claim 11,
wherein the operation data is transmitted and received by the communication unit by using an IP addresses assigned to each centrifuge.

15. The centrifuge according to claim 10,
wherein, if operation data generated by the other centrifuge is received through the communication unit, the control device stores the received operation data in the storage device.

16. The centrifuge according to claim 15,
wherein the centrifuge collates the operation data stored in the storage device with the other centrifuge through the communication unit, and exchanges the operation data, which is missing, with the other centrifuge.

17. The centrifuge according to claim 10,
wherein the centrifuge for sharing the operation data can be selected and set in advance from a plurality of centrifuges connected by the communication unit.

18. A centrifuge comprising:
a rotor configured to separate a sample;
a driving unit configured to rotate the rotor;
a control device configured to control the driving unit; and
a communication unit configured to connect the centrifuge with an external centrifuge,
wherein the control device includes a clocking unit, and
wherein the control device has a time synchronization function of performing time synchronization with the external centrifuge through the communication unit.

19. The centrifuge according to claim 18, further comprising:
a USB connector to which an external storage device is configured to be connected,
wherein the control device is configured to generate operation data, and
wherein the control device is configured to store the operation data in the external storage device through the USB connector.

20. A system for managing operation data of a centrifuge, the system comprising:
a plurality of centrifuges, each of the plurality of centrifuges including:
a rotor configured to separate a sample,
a driving unit configured to rotate the rotor,
a control device configured to control the driving unit and generate operation data,
a communication unit, and
a data storage device configured to store the operation data,
wherein the storage device of each of the plurality of centrifuges has a first storage area for storing the operation data of the corresponding centrifuge, and a second storage area for storing the operation data of another centrifuge acquired through the communication unit.
